(19) United States
(12) Patent Application Publication
(10) Pub. No.: US 2025/0083634 A1
(43) Pub. Date: Mar. 13, 2025

(54) LOAD-LIMITING SEATBELT RETRACTOR

(71) Applicant: Ford Global Technologies, LLC, Dearborn, MI (US)

(72) Inventors: Mohammad Omar Faruque, Ann Arbor, MI (US); Dean M. Jaradi, Macomb, MI (US)

(73) Assignee: Ford Global Technologies, LLC, Dearborn, MI (US)

(21) Appl. No.: 18/463,345

(22) Filed: Sep. 8, 2023

(51) Int. Cl. B60R 22/34

(52) U.S. Cl. CPC B60R 22/341; B60R 22/36

(57) ABSTRACT

A seatbelt retractor includes a frame and a spool rotatably supported by the frame. A ring is coaxial with the spool on a rotational axis and is selectively lockable with the spool. A locking device is operatively coupled between the spool and the ring to rotationally engage the spool with the ring in a locked position and rotationally disengage the spool from the ring in an unlocked position. One of the ring or the frame defines a recess and a tab is fixed to and extends from the other of the ring or the frame into the recess. When the locking device is in the locked position, the tab is elastically deformable relative to the ring and the frame when rotational force on the ring relative to the frame about the rotational axis exceeds a deformation threshold to allow rotation of the ring relative to the frame.

### BACKGROUND

A seatbelt in a vehicle may be equipped with load-limiting features. During certain vehicle impacts, a retractor of the seatbelt may lock webbing of the seatbelt from further extension from the retractor, and load-limiting features may permit some additional limited extension of the webbing when the force exerted on the webbing exceeds a load-limiting threshold. This additional extension of the webbing from the retractor limits the load applied by the webbing to the chest of an occupant, which may limit chest compression. As an example, the load-limiting features may include a torsion bar disposed within a spool of the retractor.

### BRIEF DESCRIPTION OF THE DRAWINGS

FIG. 1 is a cut-away view of a vehicle to show a seat and a seatbelt assembly.

FIG. 2 is a perspective view of a seatbelt retractor of the seatbelt assembly.

FIG. 3 is a magnified view of a portion of FIG. 2.

FIG. 4 is an end view of a portion of the seatbelt retractor with a locking device in an unlocked position.

FIG. 5 is an end view of a portion of the seatbelt retractor with a locking device in a locked position and a load limiter in a design position.

FIG. 6 is an end view of a portion of the seatbelt retractor with a locking device in a locked position and a load limiter moving from one design position to another design position.

### DETAILED DESCRIPTION

A seatbelt retractor includes a frame and a spool rotatably supported by the frame and having a rotational axis. A ring is coaxial with the spool on the rotational axis and is selectively lockable with the spool. A locking device is operatively coupled between the spool and the ring to rotationally engage the spool with the ring in a locked position and rotationally disengage the spool from the ring in an unlocked position. A tab is between the ring and the frame. One of the ring or the frame defines a recess and the tab is fixed to and extends from the other of the ring or the frame into the recess. When the locking device is in the locked position, the tab is elastically deformable relative to the ring and the frame when rotational force on the ring relative to the frame about the rotational axis exceeds a non-zero threshold to allow rotation of the ring relative to the frame. When the locking device is in the locked position, the tab locks the ring relative to the frame about the rotational axis when rotational force on the ring relative to the frame about the rotational axis is below the non-zero threshold.

The tab may extend radially from the ring to the frame.

The ring may include an inner surface extending annularly around the rotational axis and an outer surface extending annularly about the inner surface. The locking device may engage the inner surface. The tab may extend radially from the outer surface to the frame. The inner surface may include teeth and the locking device may include teeth, the teeth of the locking device being engaged with the teeth of the inner surface in the locked position and disengaged with the teeth of the inner surface in the unlocked position.

The frame may include a second ring extending annularly about the ring. One of the ring or the second ring may defines the recess and the tab may be fixed to and extend from the other of the ring or the second ring into the recess. The locking device may be a centrifugal clutch. The locking device may directly engage the ring in the locked position.

The locking device may include an inertia clutch.

The frame may include a second ring coaxial with the spool on the rotational axis. One of the ring or the second ring may define the recess and the tab may be fixed to and extend from the other of the ring or the second ring into the recess. The second ring may extend annularly about the ring.

The seatbelt retractor may include a plurality of tabs, including the tab, between the ring and the frame. The tabs may be spaced circumferentially about the ring. One of the ring or the frame may define a plurality of recesses and the tabs may be fixed to and extend from the other of the ring or the frame into the recesses. When the locking device is in the locked position, the tabs may be elastically deformable relative to the ring and the frame when rotational force on the ring relative to the frame about the rotational axis exceeds a non-zero threshold to allow rotation of the ring relative to the frame. When the locking device is in the locked position, the tabs may lock the ring relative to the frame about the rotational axis when rotational force on the ring relative to the frame about the rotational axis is below the non-zero threshold. The tabs may be spaced equidistantly annularly about the ring. The recesses and tabs may be positioned so that the tabs are simultaneously received in respective recesses. Each of the tabs may have a common size and shape and each of the recesses have a common size and shape. The ring may include an inner surface extending annularly around the rotational axis and an outer surface extending annularly about the inner surface. The locking device may engage the inner surface. The tabs may extend radially from the outer surface to the frame. The frame may include a second ring extending annularly about the outer surface of the ring. One of the ring or the second ring may define the recesses and the tabs being fixed to and extend from the other of the ring or the second ring into the recess. The locking device may be a centrifugal clutch.

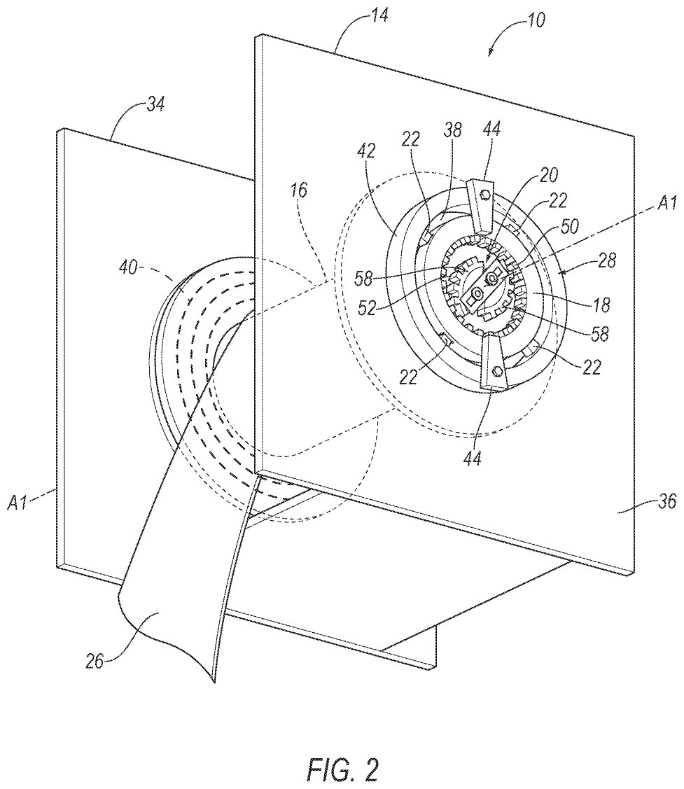

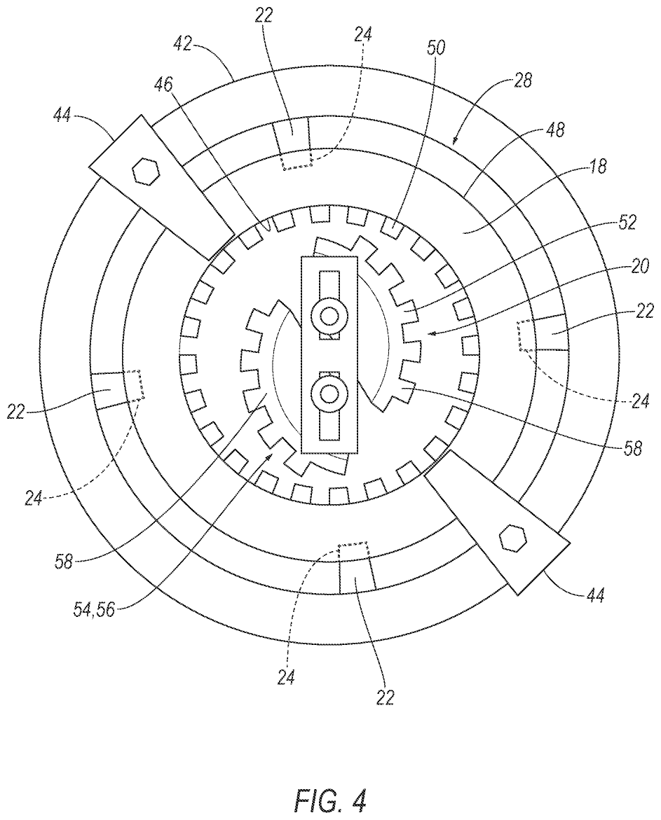

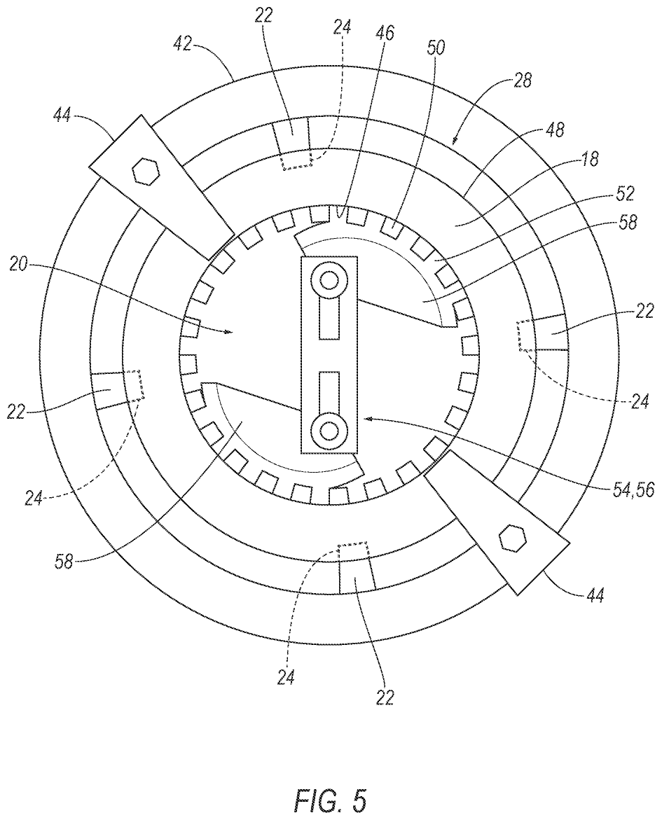

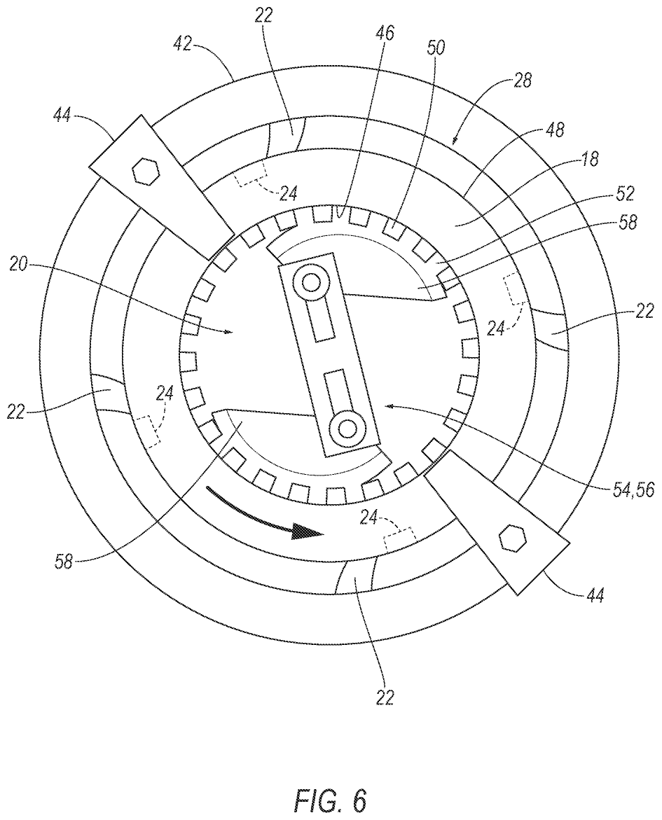

With reference to the Figures, wherein like numerals indicate like parts throughout the several views, a seatbelt retractor 10 for a vehicle 12 includes a frame 14 and a spool 16 rotatably supported by the frame 14. The spool 16 has a rotational axis A1. A ring 18 is coaxial with the spool 16 on the rotational axis A1nd is selectively lockable with the spool 16. A locking device 20 is operatively coupled between the spool 16 and the ring 18 to rotationally engage the spool 16 with the ring 18 in a locked position (FIGS. 5-6) and rotationally disengage the spool 16 from the ring 18 in an unlocked position (FIGS. 2-4). A tab 22 is between the ring 18 and the frame 14. One of the ring 18 or the frame 14 defines a recess 24 and the tab 22 is fixed to and extends from the other of the ring 18 or the frame 14 into the recess 24. When the locking device 20 is in the locked position, the tab 22 is elastically deformable relative to the ring 18 and the frame 14 when rotational force on the ring 18 relative to the frame 14 about the rotational axis A1 exceeds a deformation threshold, hereinafter referred to as a deformation threshold, to allow rotation of the ring 18 relative to the frame 14. When the locking device 20 is in the locked position, the tab 22 locks the ring 18 relative to the frame 14 about the rotational axis A1 when rotational force on the ring 18 relative to the frame 14 about the rotational axis A1 is below the deformation threshold.

The tab 22 deforms to control payout of webbing 26 when the locking device 20 is in the locked position (FIGS. 5 and 6) and force above the deformation threshold of the tab 22 is applied to the webbing 26. Specifically, when the locking device 20 is in the locked position, rotational force is transmitted from the spool 16 to the ring 18 and from the ring 18 to the tab 22. When force below the deformation threshold is applied to the tab 22, the seatbelt retractor 10 is in the design position (FIG. 5) and the tab 22 remains engaged with the recess 24 to prevent rotation of the ring 18 and spool 16 relative to the frame 14. In such a situation, shear force on the tab 22 is insufficient to deform the tab 22 to release the tab 22 from the recess 24. When force exceeding the deformation threshold of the tab 22 is applied to the tab 22, the tab 22 resiliently deforms and is disengaged from the recess 24 (FIG. 6). In such a situation, shear force on the tab 22 is sufficient to deform the tab 22 to release to tab 22 from the recess 24. This allows for a discrete amount of rotation of the ring 18 and the spool 16, which pays out a discrete amount of the webbing 26 from the spool 16. During rotation of the ring 18 and the spool 16, friction on the tab 22 acts against rotation of the ring 18 and the spool 16 relative to the frame 14. Since the tab 22 is resiliently deformable, the retractor 10 is resettable to the design position. In other words, the retractor 10 is reusable after force above the deformation threshold of the tab 22 is applied to the webbing 26 and a discrete amount of rotation of the ring 18 and the spool 16 pays out a discrete amount of webbing 26 from the spool 16.

In the example shown in the Figures, the seatbelt retractor 10 includes a load limiter 28 including a plurality of tabs 22 and recesses 24, specifically, four tabs 22 and four recesses 24. In other examples, the seatbelt retractor 10 may include any suitable number of tabs 22, i.e., one or more, and any suitable number of recesses 24, i.e., one or more. The seatbelt retractor 10 in the example shown in the Figures includes the same number of tabs 22 and recesses 24, and in other examples, the seatbelt retractor 10 may include a different number of tabs 22 than recesses 24. In examples including more than one tab 22 and more than one recess 24, the seatbelt retractor 10 has a plurality of design positions. The tabs 22 and recesses 24 may be positioned so that, when the ring 18 rotates relative to the frame 14, the tabs 22 engages the recesses 24 in each design position and the seatbelt retractor 10 is reusable from each design position. The recesses 24 and tabs 22 are positioned so that the tabs 22 are simultaneously received in respective recesses 24.

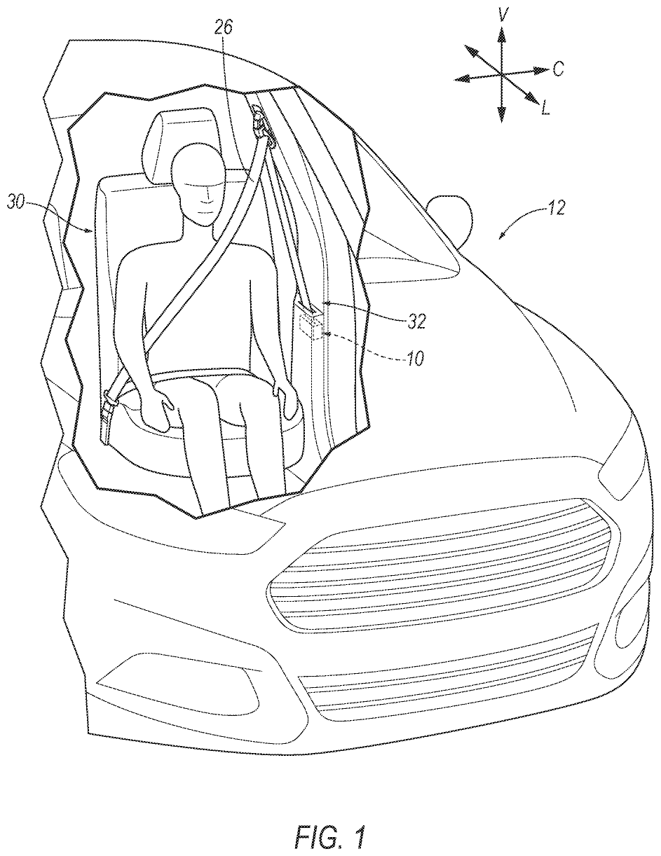

With reference to FIG. 1, the vehicle 12 may be any suitable type of ground vehicle, e.g., a passenger or commercial automobile such as a sedan, a coupe, a truck, a sport utility, a crossover, a van, a minivan, a taxi, a bus, etc. The vehicle 12 defines a vehicle-longitudinal axis L extending between a front end (not numbered) and a rear-end (not numbered) of the vehicle 12. The vehicle 12 defines a cross-vehicle axis C extending cross-vehicle from one side to the other side of the vehicle 12. The vehicle 12 defines a vertical axis V extending through a floor and ceiling of the vehicle 12. The vehicle-longitudinal axis L, the cross-vehicle axis C, and the vertical axis V are perpendicular relative to each other. The vehicle 12 includes a vehicle frame (not numbered) and a vehicle body (not numbered). The vehicle frame and/or the vehicle body defines a passenger compartment (not numbered) to house occupants of the vehicle 12. The passenger compartment may extend across the vehicle 12, i.e., from one side to the other side of the vehicle 12. The passenger compartment includes a front and a rear.

The vehicle 12 includes one or more seats 30 in the passenger compartment. The seats 30 may be arranged in any suitable manner in the passenger compartment. The seats 30 may be of any suitable type, e.g., a bucket seat, bench seat, etc.

The vehicle 12 includes one or more seatbelt assemblies 32. Specifically, one or more of the seatbelt assemblies 32 includes the seatbelt retractor 10 and the webbing 26 extendable from the seatbelt retractor 10. The vehicle 12 may include any suitable number of seatbelt assemblies 32, for example, one seatbelt assembly 32 for each seat 30. In the example shown in the Figures, one seat 30 at a front-left position is shown to include the seatbelt assembly 32, and any seat in any position in the passenger compartment may include the seatbelt assembly 32.

The seatbelt assembly 32, when fastened, is designed to control the kinematics of the occupant during 18 certain vehicle impacts or sudden stops. The seatbelt assembly 32 may include an anchor coupled to the webbing 26, and a clip that engages a buckle. Each seatbelt assembly 32 may be disposed adjacent to one of the seats 30. The seatbelt assembly 32, when fastened, is designed to control certain kinematics of the occupant during 18 certain vehicle impacts or sudden stops. The seatbelt assembly 32 may be a three-point harness, meaning that the webbing 26 is attached at three points around the occupant when fastened. The seatbelt assembly 32 may, alternatively, include another arrangement of attachment points.

The webbing 26 may extend continuously from the seatbelt retractor 10 to the anchor. For example, one end of the webbing 26 feeds into the seatbelt retractor 10, and the other end of the webbing 26 is fixed to the anchor. The anchor may, for example, be fixed to the seat and/or to the vehicle body, e.g., the pillar, the floor, etc. The webbing 26 may be fabric, e.g., polyester. The clip slides freely along the webbing 26 and, when engaged with the buckle, divides the webbing 26 into a lap band and a shoulder band.

The seatbelt retractor 10 provides payout and retraction of the webbing 26, e.g., via rotation of the spool 16. As described above, the seatbelt retractor 10 includes the frame 14. The frame 14 supports other components of the seatbelt retractor 10. The frame 14 may include a first plate 34 and a second plate 36 spaced from the first plate 34 along the rotational axis A1 of the spool 16. The frame 14 may be of any suitable size and shape. The frame 14 may be of any suitable material, e.g., plastic, metal, composite, etc. The seatbelt retractor 10 may be supported at any suitable location in the vehicle 12.

The spool 16 is rotatably supported by the frame 14. For example, a first end of the spool 16 is rotatably supported by the frame 14, e.g., the first plate 34, and a second end of the spool 16 is rotatably supported by the frame 14, e.g., the second plate 36. The spool 16 is elongated along the rotational axis A1 from the first end to the second end. The spool 16 is rotatable about the axis A1. For example, the first end of the spool 16 may be supported in an opening defined by the first plate 34 and the second end may be supported in an opening 38 defined by the second plate 36. In other words, the spool 16 is free to rotate about the axis A1 relative to the first plate 34 and the second plate 36 when the locking device 20 is unlocked.

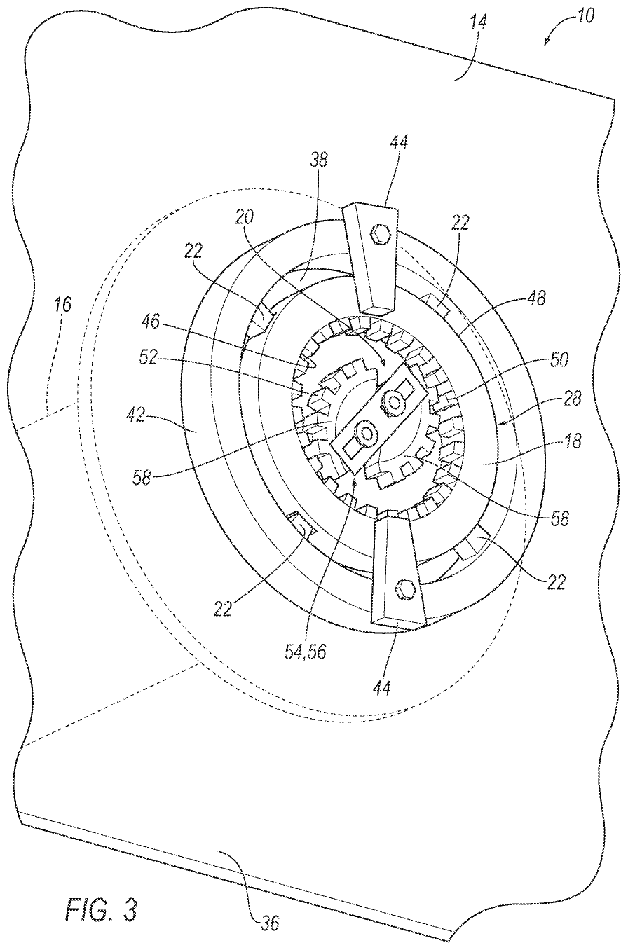

With reference to FIGS. 2 and 3, the spool 16 may include a cylinder and two flanges (not numbered). The cylinder may be elongated along the axis A1 between the first end and the second end. As an example, shown in the Figures, the spool 16 includes one flange at the first end of the spool 16 and the other flange at the second end of the spool 16. The cylinder is elongated from one flange to the other flange. The flanges maintain the position of the webbing 26 relative to the spool 16, i.e., the webbing 26 is between the flanges. As shown in the Figures, the flanges extend in a direction radially away from the axis A1.

The webbing 26 is supported by the spool 16. Specifically, the webbing 26 is supported on the cylinder between the two flanges. The cylinder may include a slot elongated along the axis A1. The slot is sized and shaped to receive the webbing 26. The webbing 26 may be in the slot and wound around the spool 16. The webbing 26 may be, for example, fixed to the spool 16 through the slot. The webbing 26 may be fixed to the spool 16 in any suitable manner.

The seatbelt retractor 10 includes a return spring 40. The return spring 40 may be supported by the frame 14 and operatively engaged with the spool 16 to apply torque to the spool 16 relative to the frame 14. The return spring 40 may be coupled to the spool 16 and the frame 14. In the example shown in FIG. 2, the return spring 40 is disposed at the first plate 34 of the frame 14 and is engaged with the first end of the spool 16 to retract the webbing 26, i.e., when the locking device 20 is unlocked. The return spring 40 may be loaded in tension or compression when the webbing 26 is fully retracted, and the return spring 40 may be further loaded in either tension or compression when the webbing 26 is extended from the spool 16. When force is exerted on the webbing 26, the return spring 40 may uncoil and the webbing 26 may payout from the spool 16. When the force applied to the webbing 26 is released, no rotational force is exerted on the spool 16 and the return spring 40 exerts a force tending to retract the webbing 26. The return spring 40 may be, for example, a spiral torsion return spring 40 or any other suitable type of return spring 40.

The seatbelt retractor 10 may be free of having a torsion bar between the spool 16 and the frame 14. In other words, the seatbelt retractor 10 may not include a conventional torsion bar between the locking device 20 and the spool 16.

As set forth above, the load limiter 28 between the spool 16 and the frame 14. The load limiter 28 is selectively engageable with the spool 16 by the locking device 20. In other words, the locking device 20 may couple the spool 16 to the load limiter 28 to deliver rotational force of the spool 16 to the load limiter 28. In the event the force delivered to the spool 16 is below the deformation threshold, the load limiter 28 stays in the design position and the lock and the load limiter 28 prevent rotation of the spool 16 relative to the frame 14 to prevent extension of webbing 26 from the seatbelt retractor 10. In the event the force delivered to the spool 16 is above the deformation threshold, the load limiter 28 allows for a discrete amount of rotation of the ring 18 and the spool 16, which pays out a discrete amount of the webbing 26 from the spool 16.

The ring 18 is coaxial with the spool 16 on the rotational axis A1. The spool 16 is rotatable relative to the ring 18 when the locking device 20 is unlocked, as described further below. When the locking device 20 is locked, the locking device 20 couples the spool 16 and the ring 18 so that the spool 16 and the ring 18 rotate together in unison when rotational force applied by the spool 16 to the ring 18 exceeds the deformation threshold of the tabs 22. The locking device 20 is releasably locked to the ring 18, as described further below.

The load limiter 28 includes the ring 18, at least one tab 22, and at least one recess 24. Specifically, as set forth above, the example shown in the Figures includes four tabs 22 and four recesses 24. One of the ring 18 or the frame 14 defines the recesses 24 and the tabs 22 are fixed to and extend from the other of the ring 18 or the frame 14 into the recesses 24, respectively. In the example shown in the Figures, the ring 18 defines the recesses 24 and the tabs 22 are fixed to the frame 14. In other examples, the frame 14 may define the recesses 24 and the tabs 22 may be fixed to the ring 18.

The frame 14 may include a second ring 42, as shown in the example in the Figures. As an example, the second ring 42 is fixed to the second plate 36, e.g., by welding, adhesive, unitary formation, etc. The second ring 42 extends annularly about the ring 18. The second ring 42 is coaxial with the ring 18 and the spool 16 on the rotational axis A1. One of the ring 18 or the second ring 42 defines the recesses 24 and the tabs 22 are fixed to and extend from the other of the ring 18 or the second ring 42 into the recesses 24, respectively. In other examples that do not include the second ring 42, one of the ring 18 or the second ring 42 defines the recesses 24 and the tabs 22 are fixed to and extend from the other of the ring 18 or the second ring 42 into the recesses 24, respectively. In any event, in examples including multiple tabs 22 and recesses 24, the tabs 22 and recesses 24 are spaced annularly about the rotational axis A1.

The ring 18 and the frame 14, e.g., the second ring 42, define a circular path of relative movement of the tabs 22 and recesses 24. The tabs 22 and the recesses 24 are concentric on the circular path such that, as the ring 18 rotates relative to the frame 14 in the examples described herein, the tabs 22 and the recesses 24 are aligned so that the tabs 22 engage the recesses 24 after rotation. The tabs 22 are spaced circumferentially from each other along the circular path and the recesses 24 are spaced circumferentially from each other along the circular path.

The ring 18 is supported by the frame 14. In the example in the Figures, the seatbelt retractor 10 includes retainers 44 that retain the ring 18 to the frame 14. Specifically, the retainers 44 retain the ring 18 in the opening of the second plate 36. The retainers 44 abut the ring 18 and prevent movement of the ring 18 along the rotational axis A1 away from the spool 16. The ring 18 slides along the retainers as the ring 18 rotates relative to the frame 14.

The ring 18 includes an inner surface 46 extending annularly around the rotational axis A1nd an outer surface 48 extending annularly about the inner surface 46. In the example shown in the Figures, the inner surface 46 includes teeth 50 and the locking device 20 includes teeth 52 that selectively engage the teeth 50 on the inner surface 46 of the ring 18.

As set forth above, when the locking device 20 is in the locked position, the tabs 22 are elastically deformable relative to the ring 18 and the frame 14 when rotational force on the ring 18 relative to the frame 14 about the rotational axis A1 exceeds the deformation threshold to allow rotation of the ring 18 relative to the frame 14. When the locking device 20 is in the locked position, the tabs 22 lock the ring 18 relative to the frame 14 about the rotational axis A1 when rotational force on the ring 18 relative to the frame 14 about the rotational axis A1 is below the deformation threshold. The deformation threshold is designed to selectively prevent rotation of the ring 18 relative to the frame 14, and thus prevent rotation of the ring 18 relative to the frame 14, to control the kinematics of an occupant to selectively allow rotation of the ring 18 relative to the frame 14, and thus pay out webbing 26 from the seatbelt retractor 10, to limit chest compression of the occupant. The threshold deformation may be based on, for example, the dimensions and geometry of the tabs 22, the dimensions and geometry of the recesses 24, the material type of the tabs 22, the length of extension of the tabs 22 into the recesses 24, etc. The threshold deformation has a magnitude above zero. The threshold deformation may be empirically calculated.

As set forth above, the tabs 22 are resiliently deformable. In other words, when the tab 22 is at a recess 24, the tab 22 has an extended position extending into the recess 24. In the event the ring 18 rotates relative to the frame 14, the tab 22 abuts the ring 18 spaced from the recess 24 and the tab 22 is deformed from the extended position. When the tab 22 is again at a recess 24 after further rotation of the ring 18 relative to the frame 14, the tab 22 again resiliently returns to the extended position.

The tabs 22 may be of any suitable type of material that allows the tabs 22 to resiliently deform. As one example, the tabs 22 may be a thermoplastic elastomer. The tabs 22 may be, for example, polyurethane.

As set forth above, the tabs 22 are fixed the frame 14 or the ring 18. In other words, the tabs 22 move relative to the frame 14/ring 18 to which the tabs 22 are fixed and move relative to the other of the frame 14 and ring 18 when the ring 18 rotates relative to the frame 14. The tabs 22 may be fixed to the frame 14 or the ring 18 by, for example, adhesive, mechanical connection, etc.

The tabs 22 extend radially from the ring 18 to the frame 14. Specifically, the tab 22 extends radially from the outer surface 48 to the frame 14. The tabs 22 are sized to extend into the respective recess 24 in the extended position.

In the example shown in the Figures, the tabs 22 have a rectangular cross-section and the recesses 24 have a cuboid shape. In other example, the tabs 22 and the recesses 24 may have any suitable shape. In some examples, including the example shown in the Figures, each of the tabs 22 have a common size and shape and each of the recesses 24 have a common size and shape.

As set forth above, the tabs 22 and the recesses 24 are spaced annularly about the ring 18. In the example shown in the Figures, the tabs 22 are spaced from each other equidistantly about the ring 18 and the recesses 24 are spaced from each other equidistantly about the ring 18. In such examples, the tabs 22 and the recesses 24 are positioned so that the tabs 22 are simultaneously received in respective recesses 24 in a design position.

The tabs 22 deform to control payout of the webbing 26 when the locking device 20 is in the locked position and load above the deformation threshold of the tabs 22 is applied to the webbing 26. Specifically, when the locking device 20 is in the locked position, rotational force is transmitted from the spool 16 to the ring 18 and from the ring 18 to the tabs 22. In the example shown in the Figures, the tabs 22 are fixed to the frame 14, specifically the second ring 42, so that when the ring 18 transmits rotational force to the tabs 22, the tabs 22 deform between the ring 18 and the frame 14 when the force transmitted from the ring 18 to the tabs 22 exceeds the deformation threshold of the tabs 22. In such a situation, in the example shown in the Figures, friction between the tabs 22 and the ring 18 resists rotation of the ring 18 relative to the frame 14. When force below the deformation threshold is applied to the tabs 22, the seatbelt retractor 10 is in the design position and the tabs 22 remains engaged with the recesses 24 to prevent rotation of the ring 18 and spool 16 relative to the frame 14. When force exceeding the deformation threshold of the tabs 22 is applied to the tabs 22, the tabs 22 resiliently deform and are disengaged from the respective recesses 24. This allows for a discrete amount of rotation of the ring 18 and the spool 16, which pays out a discrete amount of the webbing 26 from the spool 16. During 18 this rotation, the tabs 22 each reach another of the recesses 24 and resiliently extend into the respective recesses 24. In the event the force on ring 18 is below the deformation threshold, e.g., due to decreased force on the webbing 26 or unlocking of the locking device 20, the tabs 22 remain engaged in the recesses 24 and the seatbelt retractor 10 is in the design position. In the event the force on the ring 18 is above deformation threshold after the tabs 22 engage the recesses 24, the tabs 22 again resiliently deform, allowing for another discrete amount of rotation of the ring 18 and the spool 16. The rotation of the ring 18 and the spool 16 relative to the frame 14 ceases and the seatbelt retractor 10 returns to the design position when the force applied by the spool 16 to the ring 18 falls below the deformation threshold of the tabs 22. Thus, the retractor, specifically the load limiter 28, is resettable to the design position. In other words, the retractor is reusable after force above the deformation threshold of the tabs 22 is applied to the webbing 26 and a discrete amount of rotation of the ring 18 and the spool 16 pays out a discrete amount of webbing 26 from the spool 16.

As set forth above, the ring 18 is selectively lockable with the spool 16. The locking device 20 is operatively coupled between the spool 16 and the ring 18 to rotationally engage the spool 16 with the ring 18 in a locked position and rotationally disengage the spool 16 from the ring 18 in an unlocked position. In the example shown in the Figures, the locking device 20 directly engages the ring 18 in the locked position. For example, the inner surface 46 includes teeth 50 and the locking device 20 includes teeth 52. In such examples, the teeth 50 of the locking device 20 are engaged with the teeth 52 of the inner surface 46 in the locked position and disengaged with the teeth 52 of the inner surface 46 in the unlocked position.

The seatbelt retractor 10 includes the locking device 20 operatively coupled between the spool 16 and the tab 22 to engage the spool 16 with the tab 22. As shown in FIG. 2, the locking device 20 may be supported at the second end of the spool 16 and the second plate 36 of the frame 14. The spool 16 may be between the return spring 40 and the locking device 20 along the axis A1. The locking device 20 is movable from an unlocked position, shown in FIG. 2, in which torque is not transferred from the spool 16 to the tab 22, to a locked position in which torque is transferred from the spool 16 to the tab 22. Specifically, in the unlocked position, the spool 16 rotates relative to the ring 18 and in the locked position the spool 16 rotates as a unit with the ring 18.

The locking device 20 may be lockable with the ring 18. Specifically, the locking device 20 is fixed to and rotates with the spool 16 when the locking device 20 is unlocked with the ring 18. When locked with the ring 18, the locking device 20 couples the ring 18 and the spool 16 so that the ring 18 and the spool 16 rotate together as a unit. The locking device 20 may include an inertia clutch 54 that moves the locking device 20 from the unlocked position to the locked position in response to a vehicle 12 deceleration. The inertia clutch 54 may be supported by the spool 16 and lockable with the ring 18. For example, the inertia clutch 54 may include one or more pawls 58 supported at the second end of the spool 16. As an example, the inertia clutch 54 may be a centrifugal clutch 56 in which centrifugal force from an increase in rotation speed of the spool 16, e.g., when a certain load is applied to the webbing 26, may urge the pawls 58 radially outward to the locked position. As another example, the locking device 20 may be moved from the unlocked position to the locked position in response to deceleration of the vehicle 12, e.g., a sudden slowing of the vehicle 12, sudden stop, impact, etc., of the vehicle 12. The locking device 20 may be moved from the unlocked position to the locked position in response to an activation sensor (not shown). The activation sensor senses sudden deceleration of the vehicle 12 and triggers activation of the locking device 20, i.e., moves the locking device 20 to the locked position. The locking device 20 may include any suitable structure for selectively transferring 18 torque, e.g., including conventional structures. The locking device 20 is resettable. In other words, the locking device 20 may be unlocked from the ring 18, e.g., when the inertia clutch is released, to allow the spool 16 to rotate freely relative to the ring 18. The locking device 20 may be of the type known in the art including, in some examples, those used in emergency-locking retractors.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A seatbelt retractor comprising:
a frame;
a spool rotatably supported by the frame and having a rotational axis;
a ring coaxial with the spool on the rotational axis and selectively lockable with the spool; and
a locking device operatively coupled between the spool and the ring to rotationally engage the spool with the ring in a locked position and rotationally disengage the spool from the ring in an unlocked position; and
a tab between the ring and the frame;
one of the ring or the frame defining a recess and the tab being fixed to and extending from the other of the ring or the frame into the recess;
when the locking device is in the locked position, the tab is elastically deformable relative to the ring and the frame when rotational force on the ring relative to the frame about the rotational axis exceeds a non-zero threshold to allow rotation of the ring relative to the frame; and
when the locking device is in the locked position, the tab locks the ring relative to the frame about the rotational axis when rotational force on the ring relative to the frame about the rotational axis is below the non-zero threshold.

2. The seatbelt retractor as set forth in claim 1, wherein the tab extends radially from the ring to the frame.

3. The seatbelt retractor as set forth in claim 1, wherein:
the ring includes an inner surface extending annularly around the rotational axis and an outer surface extending annularly about the inner surface;
the locking device engages the inner surface; and
the tab extends radially from the outer surface to the frame.

4. The seatbelt retractor as set forth in claim 3, wherein the inner surface includes teeth and the locking device includes teeth, the teeth of the locking device being engaged with the teeth of the inner surface in the locked position and disengaged with the teeth of the inner surface in the unlocked position.

5. The seatbelt retractor as set forth in claim 4, wherein the frame includes a second ring extending annularly about the ring, one of the ring or the second ring defining the recess and the tab being fixed to and extending from the other of the ring or the second ring into the recess.

6. The seatbelt retractor as set forth in claim 4, wherein the locking device is a centrifugal clutch.

7. The seatbelt retractor as set forth in claim 1, wherein the locking device directly engages the ring in the locked position.

8. The seatbelt retractor as set forth in claim 1, wherein the locking device includes an inertia clutch.

9. The seatbelt retractor as set forth in claim 1, wherein the frame includes a second ring coaxial with the spool on the rotational axis, one of the ring or the second ring defining the recess and the tab being fixed to and extending from the other of the ring or the second ring into the recess.

10. The seatbelt retractor as set forth in claim 9, wherein the second ring extends annularly about the ring.

11. The seatbelt retractor as set forth in claim 1, further comprising a plurality of tabs, including the tab, between the ring and the frame, the tabs being spaced circumferentially about the ring;
one of the ring or the frame defining a plurality of recesses and the tabs being fixed to and extending from the other of the ring or the frame into the recesses;
when the locking device is in the locked position, the tabs are elastically deformable relative to the ring and the frame when rotational force on the ring relative to the frame about the rotational axis exceeds a non-zero threshold to allow rotation of the ring relative to the frame; and
when the locking device is in the locked position, the tabs lock the ring relative to the frame about the rotational axis when rotational force on the ring relative to the frame about the rotational axis is below the non-zero threshold.

12. The seatbelt retractor as set forth in claim 11, wherein the tabs are spaced equidistantly annularly about the ring.

13. The seatbelt retractor as set forth in claim 11, wherein the recesses and tabs are positioned so that the tabs are simultaneously received in respective recesses.

14. The seatbelt retractor as set forth in claim 11, wherein each of the tabs have a common size and shape and each of the recesses have a common size and shape.

15. The seatbelt retractor as set forth in claim 11, wherein:
the ring includes an inner surface extending annularly around the rotational axis and an outer surface extending annularly about the inner surface;
the locking device engages the inner surface; and
the tabs extend radially from the outer surface to the frame.

16. The seatbelt retractor as set forth in claim 14, wherein the frame includes a second ring extending annularly about the outer surface of the ring, one of the ring or the second ring defining the recesses and the tabs being fixed to and extending from the other of the ring or the second ring into the recess.

17. The seatbelt retractor as set forth in claim 14, wherein the locking device is a centrifugal clutch.
